(19) United States
(12) Patent Application Publication
(10) Pub. No.: US 2026/0195857 A1
(43) Pub. Date: Jul. 9, 2026

(54) IMAGE SUPER-RESOLUTION METHOD, DEVICE, STORAGE MEDIUM, AND PROGRAM PRODUCT

(71) Applicant: Beijing Zitiao Network Technology Co., Ltd., Haidian District, Beijing (CN)

(72) Inventor: Hang DONG, Beijing (CN)

(21) Appl. No.: 19/131,369

(22) PCT Filed: Mar. 14, 2024
(86) PCT No.: PCT/CN2024/081634

§ 371 Date: May 20, 2025

(30) Foreign Application Priority Data
Mar. 31, 2023 (CN) 202310345195.2

(51) Int. Cl. G06T 5/50; G06T 3/4053; G06T 5/60; G06T 5/70

(52) U.S. Cl. CPC G06T 5/50; G06T 3/4053; G06T 5/60; G06T 5/70; G06T 2207/20081; G06T 2207/20221; G06T 2207/30168

(57) ABSTRACT

Embodiments of the present invention provide an image super-resolution method, a device, a storage medium, and a program product. The method includes: acquiring an image to be processed, wherein display content of the image to be processed comprises a text; according to a first super-resolution model, processing the image to be processed to obtain a first super-resolution image corresponding to the image to be processed; according to a second super-resolution model, processing the image to be processed to obtain a second super-resolution image corresponding to a text area of the text within the image to be processed, wherein a super-resolution effect of the second super-resolution model on the text area is superior to that of the first super-resolution model on the text area; and fusing the first super-resolution image and the second super-resolution image to obtain a target super-resolution image corresponding to the image to be processed.

### CROSS-REFERENCE TO RELATED APPLICATIONS

The present disclosure is based on and claims priority to Chinese Patent Application No. 202310345195.2, filed on Mar. 31, 2023, the disclosure of which is incorporated herein by reference in its entirety.

### TECHNICAL FIELD

Embodiments of the present disclosure relate to the technical field of computer and network communication, and in particular, to an image super-resolution method, a device, a storage medium and a program product.

### BACKGROUND

Super-resolution is a process of improving the resolution of an original image, aiming at performing resolution enhancement and detail restoration on the image.

In a related art, a super-resolution model is adopted to perform super-resolution processing on an image. However, since there are often a large amount of different contents in the image, and different images have different distributions and structures, especially an image containing texts, the text structure and the natural image distribution vary greatly. When the super-resolution processing is performed on the image containing texts by using the general super-resolution model, unnatural artifacts are easily generated, and the super-resolution effect of the text part is poor.

### SUMMARY

Embodiments of the present disclosure provide an image super-resolution method, a device, a storage medium and a program product, so as to improve the effect of super-resolution on an image containing texts.

In a first aspect, an embodiment of the present disclosure provides an image super-resolution method, including: obtaining an image to be processed, where display content of the image to be processed contains a text; processing the image to be processed according to a first super-resolution model to obtain a first super-resolution image corresponding to the image to be processed; processing the image to be processed according to a second super-resolution model to obtain a second super-resolution image corresponding to a text area of the text within the image to be processed, where a super-resolution effect of the second super-resolution model on the text area is better than a super-resolution effect of the first super-resolution model on the text area; and fusing the first super-resolution image and the second super-resolution image to obtain a target super-resolution image corresponding to the image to be processed.

In a second aspect, an embodiment of the present disclosure provides an image super-resolution device, including: an obtaining unit configured to obtain an image to be processed, where display content of the image to be processed contains a text; a first super-resolution unit configured to process the image to be processed according to a first super-resolution model to obtain a first super-resolution image corresponding to the image to be processed; a second super-resolution unit configured to process the image to be processed according to a second super-resolution model to obtain a second super-resolution image corresponding to a text area of the text within the image to be processed, where a super-resolution effect of the second super-resolution model on the text area is better than a super-resolution effect of the first super-resolution model on the text area; and a fusing unit configured to fuse the first super-resolution image and the second super-resolution image to obtain a target super-resolution image corresponding to the image to be processed.

In a third aspect, an embodiment of the present disclosure provides an electronic device, including: at least one processor and a memory; wherein the memory stores computer-executable instructions; and the at least one processor executes the computer-executable instructions stored in the memory, to enable the at least one processor to execute the image super-resolution method according to the first aspect and various possible designs of the first aspect.

In a fourth aspect, an embodiment of the present disclosure provides a computer-readable storage medium, where the computer-readable storage medium stores computer-executable instructions, and when the computer-executable instructions are executed by a processor, the image super-resolution method according to the first aspect and various possible designs of the first aspect is implemented.

In a fifth aspect, an embodiment of the present disclosure provides a computer program product, including computer-executable instructions, and when the computer-executable instructions are executed by a processor, the image super-resolution method according to the first aspect and various possible designs of the first aspect is implemented.

According to the image super-resolution method, device, storage medium and program product provided by the embodiments of the present disclosure, the image to be processed is obtained, where the display content of the image to be processed contains the text; the image to be processed is processed according to the first super-resolution model, to obtain the first super-resolution image corresponding to the image to be processed; the image to be processed is processed according to the second super-resolution model to obtain the second super-resolution image corresponding to the text area of the text within the image to be processed, where the super-resolution effect of the second super-resolution model on the text area is better than that of the first super-resolution model; and the first super-resolution image and the second super-resolution image are fused to obtain the target super-resolution image corresponding to the image to be processed. The image containing the text is processed by division of labor of the two super-resolution models, so that both the text area and the non-text area can obtain better super-resolution effects, and the overall effect of super-resolution on the image containing the text is improved.

### BRIEF DESCRIPTION OF THE DRAWINGS

In order to illustrate the technical solutions in the embodiments of the present disclosure or in the related art more clearly, the following will briefly introduce the drawings needed in the description of the embodiments or the related art. Obviously, the drawings in the following description are some embodiments of the present disclosure, and for those of ordinary skill in the art, other drawings can be obtained according to these drawings without paying any creative effort.

FIG. 1 is a diagram of an example of an application scenario of an image super-resolution method according to an embodiment of the present disclosure;

FIG. 2 is a schematic flowchart of an image super-resolution method according to an embodiment of the present disclosure;

FIG. 3a is a schematic flowchart of an image super-resolution method according to another embodiment of the present disclosure;

FIG. 3b is a schematic flowchart of an image super-resolution method according to another embodiment of the present disclosure;

FIG. 4a is a schematic flowchart of an image super-resolution method according to another embodiment of the present disclosure;

FIG. 4b is a schematic flowchart of an image super-resolution method according to another embodiment of the present disclosure;

FIG. 5 is a structural block diagram of an image super-resolution device according to an embodiment of the present disclosure; and

FIG. 6 is a schematic diagram of a hardware structure of an electronic device according to an embodiment of the present disclosure.

### DETAILED DESCRIPTION

In order to make the purpose, technical solutions and advantages of the embodiments of the present disclosure clearer, the technical solutions in the embodiments of the present disclosure will be clearly and completely described below with reference to the drawings in the embodiments of the present disclosure. Obviously, the described embodiments are only a part of the embodiments of the present disclosure, rather than all of them. Based on the embodiments in the present disclosure, all other embodiments obtained by those of ordinary skill in the art without paying any creative effort shall fall within the protection scope of the present disclosure.

In a related art, a super-resolution model is adopted to perform super-resolution processing on an image. However, since there are often a large amount of different contents in the image, and different images have different distributions and structures, especially an image containing texts, the text structure and the natural image distribution vary greatly.

When the super-resolution processing is performed on the image containing texts by using the general super-resolution model, since the training dataset of the general super-resolution model is mostly natural scenes with few texts, while the text structure and the natural image distribution vary greatly, the super-resolution model is more suitable for super-resolution processing of natural scene images, but is not good at super-resolution processing of images containing texts, resulting in that the text part is prone to generate unnatural artifacts, and the super-resolution effect of the text part is poor.

In order to improve the super-resolution effect of the text part, a special text super-resolution model may be adopted for processing. However, the special text super-resolution model usually only focuses on processing the text part, and the training dataset is monotonous, including only the images of the text part. When the trained text super-resolution model processes texts of real images, especially the distribution and structure of texts and backgrounds in User Generated Content (UGC) images may be relatively complex, and since the non-text part regions (background, etc.) are not considered, a relatively serious discoloration phenomenon (color cast) may occur in the text part.

In order to solve the above technical problems, an embodiment of the present disclosure provides an image super-resolution method, by obtaining an image to be processed, where display content of the image to be processed contains a text; processing the image to be processed according to a first super-resolution model to obtain a first super-resolution image corresponding to the image to be processed; processing the image to be processed according to a second super-resolution model to obtain a second super-resolution image corresponding to a text area of the text within the image to be processed, where a super-resolution effect of the second super-resolution model on a text area is better than that of the first super-resolution model; and fusing the first super-resolution image and the second super-resolution image to obtain a target super-resolution image corresponding to the image to be processed. The image containing the text is processed by division of labor of the two super-resolution models, so that both the text area and the non-text area can obtain better super-resolution effects, and the overall effect of super-resolution on the image containing the text is improved.

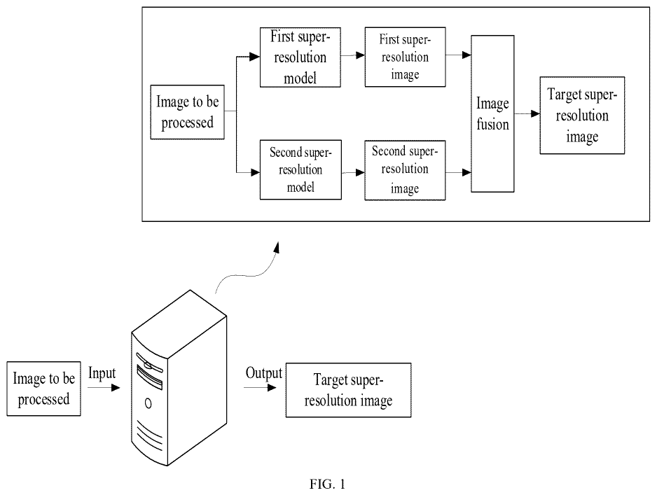

An application scenario of the image super-resolution method provided by the present disclosure is shown in FIG. 1, an execution body of which may be a processing device such as a server or a terminal device. The image to be processed is inputted into the processing device, and in the processing device, the image to be processed is processed by division of labor of the two super-resolution models, where the image to be processed is processed according to the first super-resolution model to obtain the first super-resolution image corresponding to the image to be processed; the image to be processed is processed according to the second super-resolution model to obtain the second super-resolution image corresponding to the text area of the text within the image to be processed; and the first super-resolution image and the second super-resolution image are fused to obtain the target super-resolution image corresponding to the image to be processed, and outputted or displayed.

The image super-resolution method of the present disclosure will be described in detail below with reference to specific embodiments.

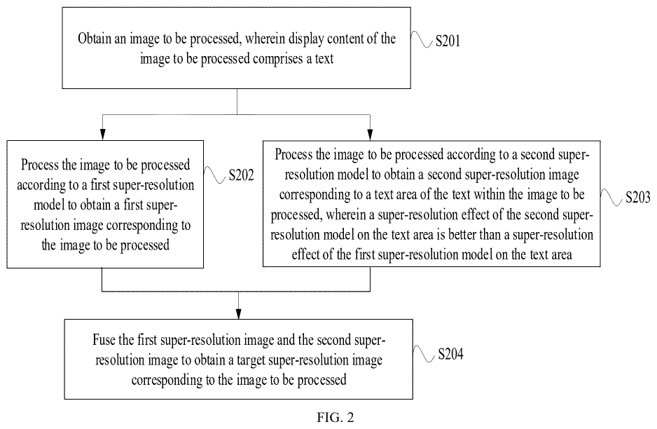

Referring to FIG. 2, FIG. 2 is a schematic flowchart of an image super-resolution method according to an embodiment of the present disclosure. The method of this embodiment may be applied in a terminal device or a server, and the image super-resolution method includes steps S201-S204.

In step S201, an image to be processed is obtained, where display content of the image to be processed contains a text.

In this embodiment, when it is necessary to perform super-resolution processing on a processing image containing a text, the image to be processed is first obtained, and a specific process of the image to be processed is not limited in this embodiment.

In step S202, the image to be processed is processed according to a first super-resolution model to obtain a first super-resolution image corresponding to the image to be processed.

In this embodiment, the first super-resolution model is a general model for performing super-resolution processing on an image, which can be pre-trained, and the training data of which can be any high-resolution image and a corresponding degraded image, where the resolution of the degraded image is lower than that of the high-resolution image, the degraded image is used as an input to the first super-resolution model, and the corresponding high-resolution image is used as a ground truth to train the first super-resolution model. In some embodiments, the high-resolution image in the training data of the first super-resolution model may include an image containing a text or an image not containing a text, so that the trained first super-resolution model can perform super-resolution processing on the image not containing a text or the image containing a text. However, since the training process is not targeted, the effect of the first super-resolution model performing super-resolution processing on the image containing a text is poor. Alternatively, the high-resolution image in the training data of the first super-resolution model only includes the image not containing a text, so that the first super-resolution model is trained in a targeted manner, and the effect of processing the image not containing a text is good. It should be noted that the specific model of the first super-resolution model is not limited in this embodiment, and may be any machine learning model or other models.

In this embodiment, based on the first super-resolution model obtained through the above training, the super-resolution processing is performed on the overall image to be processed, that is, the image to be processed is inputted into the first super-resolution model, and the first super-resolution model performs the super-resolution processing and outputs the first super-resolution image corresponding to the image to be processed. Since the first super-resolution model does not have targeted training for the super-resolution processing of texts, the super-resolution effect of the first super-resolution model on the non-text area in the image is relatively good, while the super-resolution effect on the text area is relatively poor.

In step S203, the image to be processed is processed according to a second super-resolution model to obtain a second super-resolution image corresponding to a text area of the text within the image to be processed, where a super-resolution effect of the second super-resolution model on the text area is better than a super-resolution effect of the first super-resolution model on the text area.

In this embodiment, the second super-resolution model is pre-trained in a targeted manner for the image containing a text, so that the second super-resolution model has a good super-resolution effect on the text area, and in particular, the super-resolution effect of the second super-resolution model on the text area is better than that of the first super-resolution model. The training data of the second super-resolution model may be any high-resolution image containing a text and a corresponding degraded image, where the resolution of the degraded image is lower than that of the high-resolution image, the degraded image is used as an input to the second super-resolution model, and the corresponding high-resolution image is used as a ground truth to train the second super-resolution model. It should be noted that the specific model of the second super-resolution model is not limited in this embodiment, and may be any machine learning model or other models.

In this embodiment, based on the second super-resolution model obtained through the above training, the super-resolution processing is performed on the image to be processed, where the super-resolution processing may be performed only on the text area of the text within the image to be processed, or the super-resolution processing may be performed on the overall image to be processed, and the second super-resolution image corresponding to the text area of the text within the image to be processed is finally obtained.

It should be noted that the execution order of S203 and S204 is not limited.

In step S204, the first super-resolution image and the second super-resolution image are fused to obtain a target super-resolution image corresponding to the image to be processed.

In this embodiment, since the first super-resolution image is a super-resolution image corresponding to the overall image to be processed, and the second super-resolution image is only a super-resolution image corresponding to the text area in the image to be processed, and the super-resolution effect of the text area in the second super-resolution image is better than that of the text area in the first super-resolution image, the second super-resolution image may be fused with the first super-resolution image, and the text area in the first super-resolution image is replaced with the text area in the second super-resolution image to obtain the target super-resolution image corresponding to the image to be processed, so that the super-resolution effect of both the text area and the non-text area is good.

When fusing, the second super-resolution image may be superimposed on the first super-resolution image according to the position of the text area in the image to be processed, and the text area in the second super-resolution image covers the text area in the first super-resolution image through image superimposition to realize the replacement of the text area.

Further, considering that the first super-resolution image and the second super-resolution image are generated by different models, there may be some differences. Therefore, if the second super-resolution image is directly superimposed on the first super-resolution image, the boundary position between the second super-resolution image and the first super-resolution image may be obvious. Therefore, in this embodiment, after the second super-resolution image is superimposed on the first super-resolution image, the boundary position between the second super-resolution image and the first super-resolution image may be smoothed, so that the boundary position is in smooth transition, which makes the second super-resolution image and the first super-resolution image better fuse, and the boundary position between the second super-resolution image and the first super-resolution image is not obvious.

According to the image super-resolution method provided by this embodiment, the image to be processed is obtained, where the display content of the image to be processed contains the text; the image to be processed is processed according to the first super-resolution model to obtain the first super-resolution image corresponding to the image to be processed; the image to be processed is processed according to the second super-resolution model to obtain the second super-resolution image corresponding to the text area of the text within the image to be processed, where the super-resolution effect of the second super-resolution model on the text area is better than that of the first super-resolution model; and the first super-resolution image and the second super-resolution image are fused to obtain the target super-resolution image corresponding to the image to be processed. The image containing the text is processed by division of labor of the two super-resolution models, so that both the text area and the non-text area can obtain better super-resolution effects, and the overall effect of super-resolution on the image containing the text is improved.

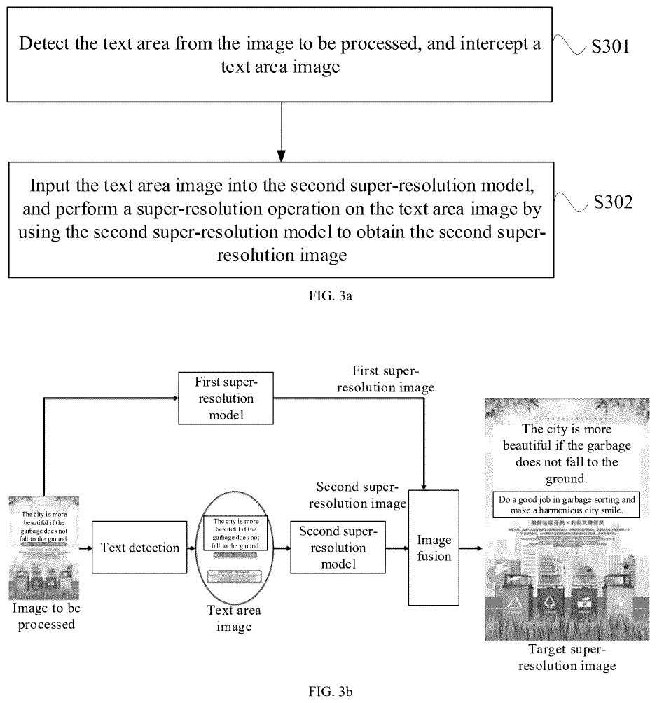

In an optional embodiment, the processing the image to be processed according to the second super-resolution model to obtain the second super-resolution image corresponding to the text area of the text within the image to be processed in S203 may, as shown in FIG. 3a, include: S301, detecting a text area from the image to be processed, and intercepting a text area image; and S302, inputting the text area image into the second super-resolution model, and performing a super-resolution operation on the text area image by using the second super-resolution model to obtain the second super-resolution image.

In this embodiment, referring to FIG. 3b, when obtaining the second super-resolution image, the text area of the text within the image to be processed may be first detected by using a text detection model, one or more low-quality text area images may be intercepted according to a detection result (a text detection box), and the text area image is separately inputted into the second super-resolution model, so that the second super-resolution model only performs the super-resolution operation on the text area image to obtain the second super-resolution image corresponding to the text area, and then the second super-resolution image is fused with the first super-resolution image obtained by the first super-resolution model to obtain the target super-resolution image. In this embodiment, the second super-resolution model does not need to perform the super-resolution processing on the entire image to be processed, but only performs the super-resolution processing on the text area image, which avoids redundant calculation, greatly improves the processing efficiency of the second super-resolution model, and reduces the resource occupancy rate.

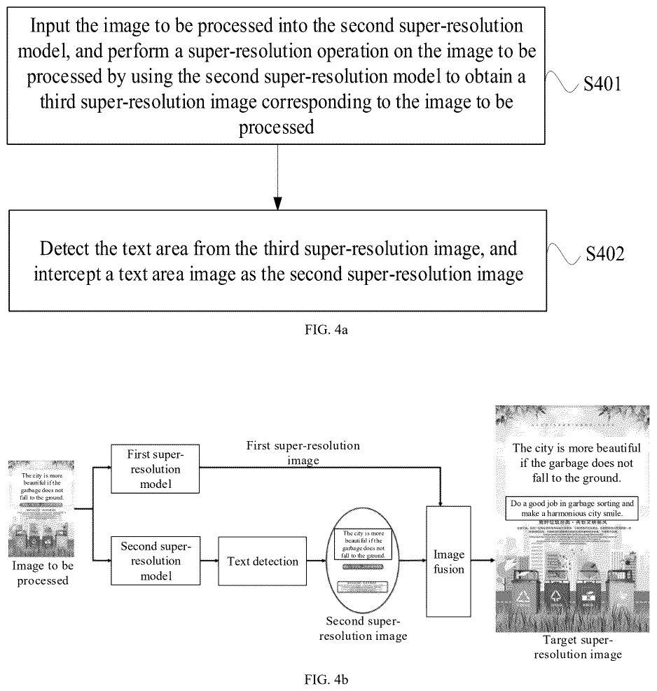

In another optional embodiment, the processing the image to be processed according to the second super-resolution model to obtain the second super-resolution image corresponding to the text area of the text within the image to be processed in S203 may, as shown in FIG. 4a, include: S401, inputting the image to be processed into the second super-resolution model, and performing a super-resolution operation on the image to be processed by using the second super-resolution model to obtain a third super-resolution image corresponding to the image to be processed; and S402, detecting a text area from the third super-resolution image, and intercepting a text area image as the second super-resolution image.

In this embodiment, considering that although there is less redundant calculation in the process of S301-S302, the text detection may be invalid when facing a very low-quality (low-definition) text image, that is, a part of very low-quality texts in the image to be processed cannot be accurately detected, so that the corresponding second super-resolution image cannot be obtained. Therefore, in this embodiment, referring to FIG. 4b, when obtaining the second super-resolution image, the second super-resolution model is preferentially used to perform the super-resolution processing on the overall image to be processed, that is, the image to be processed is inputted into the second super-resolution model for the overall super-resolution processing to obtain the third super-resolution image corresponding to the image to be processed. The definition of the text area in the third super-resolution image is significantly improved, so that the text area can be accurately detected by using the text detection model to obtain a more accurate text detection box, and the text area image is intercepted as the second super-resolution image, which is then fused with the first super-resolution image obtained by the first super-resolution model to obtain the target super-resolution image. In this embodiment, although there is redundant calculation and the calculation amount is relatively increased, it can be ensured that the image containing the low-definition text can also stably obtain the corresponding second super-resolution image, and the problem that the low-definition text cannot be detected by the text detection model and cannot be processed by the second super-resolution model is avoided.

Based on the above embodiments, the first super-resolution model may be trained by using a conventional training method, and the training data of which may be any high-resolution image and a corresponding degraded image, where the resolution of the degraded image is lower than that of the high-resolution image. The high-resolution image may include an image containing a text or an image not containing a text, or the high-resolution image may only include the image not containing a text. In the training process, the degraded image is used as an input to the first super-resolution model, and the corresponding high-resolution image is used as a ground truth. The specific training process will not be repeated here.

Based on the above embodiments, the second super-resolution model may also be trained by using a conventional training method. Multiple high-resolution original images containing texts and degraded images corresponding to the original images may be obtained, where the resolution of a degraded image in the degraded images is lower than a resolution of an original image in the original images corresponding to the degraded image. The groups of original images and the degraded images corresponding to the original images are used as training data, and in the training process, the degraded images are used as inputs to the second super-resolution model, and the corresponding high-resolution original images are used as ground truths to train the second super-resolution model. The specific training process will not be repeated here. In this embodiment, since each image in the training data includes a text area and a background (a non-text area), the text and its background are incorporated into the training together. Compared with other text super-resolution datasets (only the pure text part in the image is used for training), the second super-resolution model can better perform super-resolution processing on texts of different colors, and reduce the color cast phenomenon.

In some embodiments, when obtaining multiple original images containing texts and the degraded images corresponding to the original images, multiple original images containing texts may be obtained. For example, a large number of high-resolution original images containing more texts are collected from a professional dataset and a UGC scene, and the degradation processing is performed on each of the original images by simulating a degradation process to obtain the degraded image corresponding to the each of the original images.

In some embodiments, considering that in the actual image super-resolution processing process, there are many screenshots from videos. These screenshots, in the process of compression and saving, not only have noise during image compression, but also include noise of video compression. Therefore, the above-mentioned second super-resolution model obtained by only using the image dataset for training cannot well handle artifacts in video screenshots. In particular, texts have strong structural features, and artifacts generated by video compression and image compression are quite different. Therefore, in this embodiment, a video screenshot containing texts is incorporated as training data.

Specifically, a video file containing texts may be obtained, and an original video frame containing texts is obtained as the original image. The video file is compressed, thereby increasing video compression noise, that is, a video frame obtained from the compressed video file has video compression noise. A target video frame corresponding to the original video frame is obtained from the compressed video file according to the original video frame. Degradation processing is performed on the target video frame, that is, image compression noise is added to obtain a degraded image corresponding to the original image, which has both video compression noise and image compression noise. Training the second super-resolution image based on such original image and degraded image can enable the second super-resolution image to achieve better super-resolution effect on texts of video screenshots.

Corresponding to the image super-resolution method in the above embodiments, FIG. 5 is a structural block diagram of an image super-resolution device provided by an embodiment of the present disclosure. For ease of explanation, only parts related to the embodiments of the present disclosure are shown. Referring to FIG. 5, the image super-resolution device 500 includes: an obtaining unit 501, a first super-resolution unit 502, a second super-resolution unit 503, and a fusing unit 504.

The obtaining unit 501 is configured to obtain an image to be processed, where display content of the image to be processed contains a text.

The first super-resolution unit 502 is configured to process the image to be processed according to a first super-resolution model to obtain a first super-resolution image corresponding to the image to be processed.

The second super-resolution unit 503 is configured to process the image to be processed according to a second super-resolution model to obtain a second super-resolution image corresponding to a text area of the text within the image to be processed, where a super-resolution effect of the second super-resolution model on the text area is better than a super-resolution effect of the first super-resolution model on the text area.

The fusing unit 504 is configured to fuse the first super-resolution image and the second super-resolution image to obtain a target super-resolution image corresponding to the image to be processed.

In one or more embodiments of the present disclosure, the second super-resolution unit 503, when processing the image to be processed according to the second super-resolution model to obtain the second super-resolution image corresponding to the text area of the text within the image to be processed, is configured to: detect a text area from the image to be processed, and intercept a text area image; and input the text area image into the second super-resolution model, and perform a super-resolution operation on the text area image by using the second super-resolution model to obtain the second super-resolution image.

In one or more embodiments of the present disclosure, the second super-resolution unit 503, when processing the image to be processed according to the second super-resolution model to obtain the second super-resolution image corresponding to the text area of the text within the image to be processed, is configured to: input the image to be processed into the second super-resolution model, and perform a super-resolution operation on the image to be processed by using the second super-resolution model to obtain a third super-resolution image corresponding to the image to be processed; and detect a text area from the third super-resolution image, and intercept a text area image as the second super-resolution image.

In one or more embodiments of the present disclosure, the fusing unit 504, when fusing the first super-resolution image and the second super-resolution image, is configured to superimpose the second super-resolution image on the first super-resolution image according to a position of the text area in the image to be processed.

In one or more embodiments of the present disclosure, the fusing unit 504, after superimposing the second super-resolution image on the first super-resolution image, is further configured to smooth a boundary position between the second super-resolution image and the first super-resolution image.

In one or more embodiments of the present disclosure, the device further includes a training unit, configured to: obtain multiple original images containing texts and degraded images corresponding to the original images, where a resolution of a degraded image in the degraded images is lower than a resolution of an original image in the original images corresponding to the degraded image; and take groups of the original images and the degraded images corresponding to the original images as training data, and train the second super-resolution model according to the training data.

In one or more embodiments of the present disclosure, the training unit, when obtaining the multiple original images containing texts and the degraded images corresponding to the original images, is configured to: obtain the multiple original images containing texts, and perform degradation processing on each of the original images to obtain the degraded image corresponding to the each of the original images.

In one or more embodiments of the present disclosure, the training unit, when obtaining the multiple original images containing texts and the degraded images corresponding to the original images, is configured to: obtain a video file containing texts, and obtain an original video frame containing texts as the original image; compress the video file to increase video compression noise; obtain a target video frame corresponding to the original video frame from a compressed video file according to the original video frame; and perform degradation processing on the target video frame to obtain the degraded image corresponding to the original image.

The device provided by this embodiment can be used to implement the technical solutions of the above method embodiments, and the implementation principle and technical effects thereof are similar, which will not be repeated here in this embodiment.

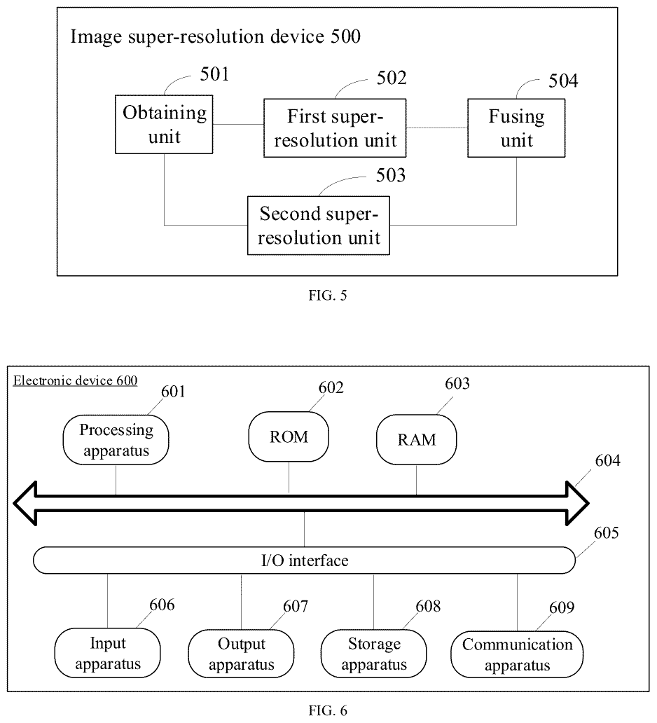

Referring to FIG. 6, it shows a schematic structural diagram of an electronic device 600 suitable for implementing the embodiments of the present disclosure, and the electronic device 600 may be a terminal device or a server. The terminal device may include, but is not limited to, mobile terminals such as a mobile phone, a laptop, a digital broadcast receiver, a personal digital assistant (abbreviated as PDA), a tablet computer, a portable media player (abbreviated as PMP), and an in-vehicle terminal (such as an in-vehicle navigation terminal), and fixed terminals such as a digital TV and a desktop computer. The electronic device shown in FIG. 6 is only an example, and should not bring any limitation to the function and usage scope of the embodiments of the present disclosure.

As shown in FIG. 6, the electronic device 600 may include a processing apparatus (such as a central processing unit and a graphics processing unit) 601, which can perform various appropriate actions and processing according to a program stored in a read-only memory (abbreviated as ROM) 602 or a program loaded from a storage apparatus 608 into a random access memory (abbreviated as RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatus may be connected to the I/O interface 605: an input apparatus 606, including, for example, a touch screen, a touchpad, a keyboard, a mouse, a camera, a microphone, an accelerometer, a gyroscope, etc.; an output apparatus 607, including, for example, a liquid crystal display (abbreviated as LCD), a speaker, a vibrator, etc.; a storage apparatus 608, including, for example, a magnetic tape, a hard disk, etc.; and a communication apparatus 609. The communication apparatus 609 may allow the electronic device 600 to perform wireless or wired communication with other devices to exchange data. Although FIG. 6 shows the electronic device 600 having various apparatus, it should be understood that not all of the illustrated apparatus are required to be implemented or provided. Alternatively, more or fewer apparatus may be implemented or provided.

In particular, according to the embodiments of the present disclosure, the process described above with reference to the flowcharts can be implemented as a computer software program. For example, the embodiments of the present disclosure include a computer program product, which includes a computer program carried on a computer-readable medium, and the computer program contains program codes for executing the method shown in the flowcharts. In such embodiments, the computer program may be downloaded and installed from the network through the communication apparatus 609, or installed from the storage apparatus 608, or installed from the ROM 602. When the computer program is executed by the processing apparatus 601, the above functions defined in the method of the embodiments of the present disclosure are executed.

It should be noted that the above-mentioned computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program, and the program may be used by or in combination with an instruction execution system, apparatus, or device. In the present disclosure, the computer-readable signal medium may include a data signal propagated in a baseband or as a part of a carrier wave, in which computer-readable program codes are carried. Such propagated data signal may take many forms, including but not limited to an electromagnetic signal, an optical signal, or any suitable combination thereof. The computer-readable signal medium may also be any computer-readable medium other than the computer-readable storage medium, and the computer-readable signal medium may send, propagate, or transmit a program for use by or in combination with an instruction execution system, apparatus, or device. The program codes contained in the computer-readable medium may be transmitted by any suitable medium, including but not limited to an electric wire, an optical cable, RF (radio frequency), etc., or any suitable combination thereof.

The above computer-readable medium may be included in the above electronic device, or may exist alone without being assembled into the electronic device.

The above computer-readable medium carries one or more programs, and when the one or more programs are executed by the electronic device, the electronic device is caused to execute the method shown in the above embodiments.

The computer program codes for performing the operations of the present disclosure may be written in one or more programming languages or a combination thereof, where the above-mentioned programming languages include object-oriented programming languages such as Java, Smalltalk, C++, and also include conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. In the scenario related to the remote computer, the remote computer may be connected to the user computer through any type of network, including a local area network (abbreviated as LAN) or a wide area network (abbreviated as WAN), or may be connected to an external computer (for example, connected via the Internet using an Internet service provider).

The flowcharts and block diagrams in the drawings illustrate the architecture, functionality, and operation of possible implementations of the systems, methods, and computer program products according to various embodiments of the present disclosure. In this regard, each block in the flowcharts or block diagrams may represent a module, a program segment, or a part of codes, and the module, the program segment, or the part of codes contains one or more executable instructions for implementing specified logical functions. It should also be noted that, in some alternative implementations, the functions marked in the blocks may also occur in an order different from those marked in the drawings. For example, two blocks shown in succession may, in fact, be executed substantially in parallel, or the two blocks may sometimes be executed in a reverse order, depending upon the functionality involved. It should also be noted that, each block in the block diagrams and/or flowcharts and a combination of blocks in the block diagrams and/or flowcharts may be implemented by a special-purpose hardware-based system that performs the specified functions or operations, or may also be implemented by a combination of special-purpose hardware and computer instructions.

The units involved in the embodiments described in the present disclosure may be implemented in software or hardware. Among them, the name of a unit does not constitute a limitation of the unit itself under certain circumstances, for example, a first obtaining unit may also be described as “a unit for obtaining at least two Internet protocol addresses”.

The functions described herein above may be performed, at least in part, by one or more hardware logic components. For example, without limitation, exemplary types of hardware logic components that can be used include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination thereof.

In a first aspect, according to one or more embodiments of the present disclosure, an image super-resolution method is provided, including: obtaining an image to be processed, where display content of the image to be processed contains a text; processing the image to be processed according to a first super-resolution model to obtain a first super-resolution image corresponding to the image to be processed; processing the image to be processed according to a second super-resolution model to obtain a second super-resolution image corresponding to a text area of the text within the image to be processed, where a super-resolution effect of the second super-resolution model on the text area is better than a super-resolution effect of the first super-resolution model on the text area; and fusing the first super-resolution image and the second super-resolution image to obtain a target super-resolution image corresponding to the image to be processed.

According to one or more embodiments of the present disclosure, the processing the image to be processed according to the second super-resolution model to obtain the second super-resolution image corresponding to the text area of the text within the image to be processed includes: detecting a text area from the image to be processed, and intercepting a text area image; and inputting the text area image into the second super-resolution model, and performing a super-resolution operation on the text area image by using the second super-resolution model to obtain the second super-resolution image.

According to one or more embodiments of the present disclosure, the processing the image to be processed according to the second super-resolution model to obtain the second super-resolution image corresponding to the text area of the text within the image to be processed includes: inputting the image to be processed into the second super-resolution model, and performing a super-resolution operation on the image to be processed by using the second super-resolution model to obtain a third super-resolution image corresponding to the image to be processed; and detecting a text area from the third super-resolution image, and intercepting a text area image, as the second super-resolution image.

According to one or more embodiments of the present disclosure, the fusing the first super-resolution image and the second super-resolution image includes: superimposing the second super-resolution image on the first super-resolution image according to a position of the text area in the image to be processed.

According to one or more embodiments of the present disclosure, after superimposing the second super-resolution image on the first super-resolution image, the image super-resolution method further includes: smoothing a boundary position between the second super-resolution image and the first super-resolution image.

According to one or more embodiments of the present disclosure, the method further includes: obtaining multiple original images containing texts and degraded images corresponding to the original images, where a resolution of a degraded image in the degraded images is lower than a resolution of an original image in the corresponding original images corresponding to the degraded image; and taking groups of the original images and the degraded images corresponding to the original images as training data, and training the second super-resolution model according to the training data.

According to one or more embodiments of the present disclosure, the obtaining multiple original images containing texts and degraded images corresponding to the original images includes: obtaining the multiple original images containing texts, and performing degradation processing on each of the original images to obtain the degraded image corresponding to the each of the original images.

According to one or more embodiments of the present disclosure, the obtaining multiple original images containing texts and degraded images corresponding to the original images includes: obtaining a video file containing texts, and obtaining an original video frame containing texts as the original image; compressing the video file to increase video compression noise; obtaining a target video frame corresponding to the original video frame from a compressed video file according to the original video frame; and performing degradation processing on the target video frame to obtain the degraded image corresponding to the original image.

In a second aspect, according to one or more embodiments of the present disclosure, an image super-resolution device is provided, including: an obtaining unit configured to obtain an image to be processed, where display content of the image to be processed contains a text; a first super-resolution unit configured to process the image to be processed according to a first super-resolution model to obtain a first super-resolution image corresponding to the image to be processed; a second super-resolution unit configured to process the image to be processed according to a second super-resolution model to obtain a second super-resolution image corresponding to a text area of the text within the image to be processed, where a super-resolution effect of the second super-resolution model on the text area is better than a super-resolution effect of the first super-resolution model on the text area; and a fusing unit configured to fuse the first super-resolution image and the second super-resolution image to obtain a target super-resolution image corresponding to the image to be processed.

In one or more embodiments of the present disclosure, the second super-resolution unit, when processing the image to be processed according to the second super-resolution model to obtain the second super-resolution image corresponding to the text area of the text within the image to be processed, is configured to: detect a text area from the image to be processed, and intercept a text area image; and input the text area image into the second super-resolution model, and perform a super-resolution operation on the text area image by using the second super-resolution model to obtain the second super-resolution image.

In one or more embodiments of the present disclosure, the second super-resolution unit, when processing the image to be processed according to the second super-resolution model to obtain the second super-resolution image corresponding to the text area of the text within the image to be processed, is configured to: input the image to be processed into the second super-resolution model, and perform a super-resolution operation on the image to be processed by using the second super-resolution model to obtain a third super-resolution image corresponding to the image to be processed; and detect a text area from the third super-resolution image, and intercept a text area image as the second super-resolution image.

In one or more embodiments of the present disclosure, the fusing unit, when fusing the first super-resolution image and the second super-resolution image, is configured to superimpose the second super-resolution image on the first super-resolution image according to a position of the text area in the image to be processed.

In one or more embodiments of the present disclosure, the fusing unit, after superimposing the second super-resolution image on the first super-resolution image, is further configured to smooth a boundary position between the second super-resolution image and the first super-resolution image.

In one or more embodiments of the present disclosure, the device further includes a training unit, configured to: obtain multiple original images containing texts and degraded images corresponding to the original images, where a resolution of a degraded image in the degraded images is lower than a resolution of an original image in the original images corresponding to the degraded image; and take groups of the original images and the degraded images corresponding to the original images as training data, and train the second super-resolution model according to the training data.

In one or more embodiments of the present disclosure, the training unit, when obtaining the multiple original images containing texts and the degraded images corresponding to the original images, is configured to: obtain the multiple original images containing texts, and perform degradation processing on each of the original images to obtain the degraded image corresponding to the each of the original images.

In one or more embodiments of the present disclosure, the training unit, when obtaining the multiple original images containing texts and the degraded images corresponding to the original images, is configured to: obtain a video file containing texts, and obtain an original video frame containing texts as the original image; compress the video file to increase video compression noise; obtain a target video frame corresponding to the original video frame from a compressed video file according to the original video frame; and perform degradation processing on the target video frame to obtain the degraded image corresponding to the original image.

In a third aspect, according to one or more embodiments of the present disclosure, an electronic device is provided, including: at least one processor and a memory; the memory stores computer-executable instructions; and the at least one processor executes the computer-executable instructions stored in the memory, to enable the at least one processor to execute the image super-resolution method according to the first aspect and various possible designs of the first aspect.

In a fourth aspect, according to one or more embodiments of the present disclosure, a computer-readable storage medium is provided, where the computer-readable storage medium stores computer-executable instructions, and when the computer-executable instructions are executed by a processor, the image super-resolution method according to the first aspect and various possible designs of the first aspect is implemented.

In a fifth aspect, according to one or more embodiments of the present disclosure, a computer program product is provided, including computer-executable instructions, and when the computer-executable instructions are executed by a processor, the image super-resolution method according to the first aspect and various possible designs of the first aspect is implemented.

The above description is only preferred embodiments of the present disclosure and an illustration of the applied technical principles. Those skilled in the art should understand that the scope of disclosure involved in the present disclosure is not limited to the technical solutions formed by the specific combination of the above technical features, and should also cover other technical solutions formed by any combination of the above technical features or equivalent features thereof without departing from the above disclosure concept. For example, the above technical features and the technical features with similar functions disclosed in the present disclosure (but not limited to) are replaced with each other to form a technical solution.

In addition, although operations are depicted in a particular order, this should not be understood as requiring that such operations are performed in the particular order shown or in a sequential order. Under certain circumstances, multitasking and parallel processing may be advantageous. Likewise, although the above discussion contains several specific implementation details, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments individually or in any suitable sub-combination.

Although the subject matter has been described in language specific to structural features and/or logical actions of the methods, it should be understood that the subject matter defined in the appended claims is not necessarily limited to the specific features or actions described above. Rather, the specific features and actions described above are merely example forms for implementing the claims.

1. An image super-resolution method, comprising:
obtaining an image to be processed, wherein display content of the image to be processed comprises a text;
processing the image to be processed according to a first super-resolution model to obtain a first super-resolution image corresponding to the image to be processed;
processing the image to be processed according to a second super-resolution model to obtain a second super-resolution image corresponding to a text area of the text within the image to be processed, wherein a super-resolution effect of the second super-resolution model on the text area is better than a super-resolution effect of the first super-resolution model on the text area; and
fusing the first super-resolution image and the second super-resolution image to obtain a target super-resolution image corresponding to the image to be processed.

2. The image super-resolution method according to claim 1, wherein the processing the image to be processed according to the second super-resolution model to obtain the second super-resolution image corresponding to the text area of the text within the image to be processed comprises:
detecting the text area from the image to be processed, and intercepting a text area image; and
inputting the text area image into the second super-resolution model, and performing a super-resolution operation on the text area image by using the second super-resolution model to obtain the second super-resolution image.

3. The image super-resolution method according to claim 1, wherein the processing the image to be processed according to the second super-resolution model to obtain the second super-resolution image corresponding to the text area of the text within the image to be processed comprises:
inputting the image to be processed into the second super-resolution model, and performing a super-resolution operation on the image to be processed by using the second super-resolution model to obtain a third super-resolution image corresponding to the image to be processed; and
detecting the text area from the third super-resolution image, and intercepting a text area image as the second super-resolution image.

4. The image super-resolution method according to claim 1, wherein the fusing the first super-resolution image and the second super-resolution image comprises:
superimposing the second super-resolution image on the first super-resolution image according to a position of the text area in the image to be processed.

5. The image super-resolution method according to claim 4, wherein after superimposing the second super-resolution image on the first super-resolution image, the image super-resolution method further comprises:
smoothing a boundary position between the second super-resolution image and the first super-resolution image.

6. The image super-resolution method according to claim 1, wherein the fusing the first super-resolution image and the second super-resolution image comprises:
replacing the text area in the first super-resolution image with the text area in the second super-resolution image.

7. The image super-resolution method according to claim 1, further comprising:
obtaining multiple original images containing texts and degraded images corresponding to the original images, wherein a resolution of a degraded image in the degraded images is lower than a resolution of an original image in the original images corresponding to the degraded image; and
taking groups of the original images and the degraded images corresponding to the original images as training data, and training the second super-resolution model according to the training data.

8. The image super-resolution method according to claim 7, wherein the obtaining multiple original images containing texts and degraded images corresponding to the original images comprises:
obtaining the multiple original images containing texts, and performing degradation processing on each of the original images to obtain the degraded image corresponding to the each of the original images.

9. The image super-resolution method according to claim 7, wherein the obtaining multiple original images containing texts and degraded images corresponding to the original images comprises:
obtaining a video file containing texts, and obtaining an original video frame containing texts as the original image;
compressing the video file to increase video compression noise;
obtaining a target video frame corresponding to the original video frame from a compressed video file according to the original video frame; and
performing degradation processing on the target video frame to obtain the degraded image corresponding to the original image.

10. The image super-resolution method according to claim 1, wherein the super-resolution effect of the first super-resolution model on a non-text area is better than the super-resolution effect on a text area.

11. (canceled)

12. An electronic device, comprising: at least one processor and a memory;
wherein the memory stores computer-executable instructions; and
the at least one processor executes the computer-executable instructions stored in the memory, to enable the at least one processor to:
obtain an image to be processed, wherein display content of the image to be processed comprises a text;
process the image to be processed according to a first super-resolution model to obtain a first super-resolution image corresponding to the image to be processed;
process the image to be processed according to a second super-resolution model to obtain a second super-resolution image corresponding to a text area of the text within the image to be processed, wherein a super-resolution effect of the second super-resolution model on the text area is better than a super-resolution effect of the first super-resolution model on the text area; and
fuse the first super-resolution image and the second super-resolution image to obtain a target super-resolution image corresponding to the image to be processed.

13. A non-transitory computer-readable storage medium, wherein the non-transitory computer-readable storage medium stores computer-executable instructions, and when the computer-executable instructions are executed by a processor, the computer-executable instructions cause the processor to:
obtain an image to be processed, wherein display content of the image to be processed comprises a text;
process the image to be processed according to a first super-resolution model to obtain a first super-resolution image corresponding to the image to be processed;
process the image to be processed according to a second super-resolution model to obtain a second super-resolution image corresponding to a text area of the text within the image to be processed, wherein a super-resolution effect of the second super-resolution model on the text area is better than a super-resolution effect of the first super-resolution model on the text area; and
fuse the first super-resolution image and the second super-resolution image to obtain a target super-resolution image corresponding to the image to be processed.

14. (canceled)

15. The electronic device according to claim 12, wherein the at least one processor executes the computer-executable instructions stored in the memory, to enable the at least one processor to:
detect the text area from the image to be processed, and intercept a text area image; and
input the text area image into the second super-resolution model, and perform a super-resolution operation on the text area image by using the second super-resolution model to obtain the second super-resolution image.

16. The electronic device according to claim 12, wherein the at least one processor executes the computer-executable instructions stored in the memory, to enable the at least one processor to:
input the image to be processed into the second super-resolution model, and perform a super-resolution operation on the image to be processed by using the second super-resolution model to obtain a third super-resolution image corresponding to the image to be processed; and
detect the text area from the third super-resolution image, and intercept a text area image as the second super-resolution image.

17. The electronic device according to claim 12, wherein the at least one processor executes the computer-executable instructions stored in the memory, to enable the at least one processor to:
superimpose the second super-resolution image on the first super-resolution image according to a position of the text area in the image to be processed.

18. The electronic device according to claim 17, wherein the at least one processor executes the computer-executable instructions stored in the memory, to further enable the at least one processor to:
smooth a boundary position between the second super-resolution image and the first super-resolution image after the second super-resolution image is superimposed on the first super-resolution image.

19. The non-transitory computer-readable storage medium according to claim 13, wherein the computer-executable instructions cause the processor to:
detect the text area from the image to be processed, and intercept a text area image; and
input the text area image into the second super-resolution model, and perform a super-resolution operation on the text area image by using the second super-resolution model to obtain the second super-resolution image.

20. The non-transitory computer-readable storage medium according to claim 13, wherein the computer-executable instructions cause the processor to:
input the image to be processed into the second super-resolution model, and perform a super-resolution operation on the image to be processed by using the second super-resolution model to obtain a third super-resolution image corresponding to the image to be processed; and
detect the text area from the third super-resolution image, and intercept a text area image as the second super-resolution image.

21. The non-transitory computer-readable storage medium according to claim 13, wherein the computer-executable instructions cause the processor to:
superimpose the second super-resolution image on the first super-resolution image according to a position of the text area in the image to be processed.

22. The non-transitory computer-readable storage medium according to claim 21, wherein the computer-executable instructions further cause the processor to:
smooth a boundary position between the second super-resolution image and the first super-resolution image after the second super-resolution image is superimposed on the first super-resolution image.
